(19) United States
(12) Patent Application Publication
(10) Pub. No.: US 2005/0246672 A1
(43) Pub. Date: Nov. 3, 2005

(54) Differential trace pair coupling verification tool

(76) Inventors: Karl J. Bois, Fort Collins, CO (US); David W. Quint, Fort Collins, CO (US); Mark D. Frank, Longmont, CO (US); Jerimy Nelson, Fort Collins, CO (US)

Correspondence Address: HEWLETT-PACKARD COMPANY;Intellectual Property Administration, P.O. BOX 272400, Fort Collins, CO, 80527-2400, US

(21) Appl. No.: 11/089,569

(22) Filed: Apr. 29, 2004

(51) Int. Cl. G06F 9/45

(52) U.S. Cl. 716/5

(57) ABSTRACT

A method for verifying coupling in a differential trace pair group includes reading victim properties of a victim differential trace pair and culprit properties of a plurality of culprit differential trace pairs from a circuit design database. The method also includes calculating a plurality of coupling factors based on the victim properties and the culprit properties, one from each of the plurality of culprit differential trace pairs to the victim differential trace pair. The method also includes calculating a total coupling factor for the victim differential trace pair based on the plurality of coupling factors, and flagging the victim differential trace pair if the total coupling factor exceeds a total coupling threshold level.

### BACKGROUND

Explosive growth in electronics technology has resulted in electronic devices used all around us in seemingly every facet of life. For example, communications equipment, toys, computers, automobiles, personal digital assistants (PDAs), household appliances, medical equipment, etc., all include increasingly powerful electronic circuits. As electronic devices become more powerful, however, their design and manufacture has become more complex and sensitive, particularly as their speed increases.

Although the design and manufacture of electronic circuits may be carried out in a number of ways, two steps in the design process are practically universal: first, the logical or functional design of the circuits, and second, the physical design of the circuits. In the first step, a circuit design is created in which circuit elements are selected and interconnected to implement the desired functionality of the circuit. The result of this functional design step is a logical circuit design file describing the interconnections in the circuit, such as “L1_pin A is connected to L2_pin B”.

The second of these two design steps is to generate a physical circuit layout from the logical circuit design for the desired product, such as an integrated circuit (IC), an IC package, a printed circuit board, etc. The circuit layout can be used to form a mask which can be provided to a foundry for fabrication. For example, the circuit layout describes the conductive lines or traces including their width, shape and position, and the conductive vias which connect the traces on different circuit layers.

Electronic design automation (EDA) software packages are available to aid in these two steps of electronic circuit design, including place-and-route tools and package design tools such as Allegro and Advanced Package Designer (APD), available from Cadence Design Systems, Inc. of San Jose, Calif. Allegro enables a designer to place (assign locations to circuit elements) and route (connect circuit elements with traces) a printed circuit board based on a logical circuit design and constraints specified by the designer. Similarly, APD is a software application that enables a package designer to design IC packages, laying out components and connections based on constraints or design rules specified by the designer. Other EDA software packages are available from other companies.

Many aspects of the physical layout of conductive traces must be carefully controlled in order for the circuit to operate properly. For example, properties such as trace widths, minimum trace spacing, minimum and maximum trace length, etc., impact the electrical characteristics of the circuit such as signal delay and distortion. One potential source of errors during the operation of an electrical circuit is crosstalk, or interference caused by two signals becoming partially superimposed on each other due to electromagnetic (inductive) or electrostatic (capacitive) coupling between the conductive traces carrying the signals. A common example of crosstalk is where the magnetic field from changing current flow in one conductive trace induces current in another conductive trace running parallel to the first. The coupling from one conductive trace to another may be measured as the ratio of the power in a disturbing trace (the culprit) to the induced power in the disturbed trace (the victim). The coupling factor may be expressed in any suitable fashion, such as in decibels (dB) or as a percentage, or as a ratio, etc. For example, when expressed as a ratio, a coupling factor of 0 indicates that no coupling exists, and a factor of 1 indicates that the culprit trace is entirely coupled to the victim trace, so that 100% of a signal on the culprit trace will appear on the victim trace.

Circuit designers can attempt to minimize coupling between conductive traces by simulating the circuit layout and making adjustments to the layout if coupling problems appear. However, manually calculating the coupling factor for conductive traces in a complex electrical circuit is extremely tedious and difficult, particularly when the electrical circuit includes differential pairs. A differential trace pair is a pair of conductive traces, typically (but not always) routed parallel to each other through the electrical circuit. The exemplary differential pair is balanced, with each trace in the differential pair theoretically carrying equal but opposite currents called odd-mode signals. Because the differential pair contains two traces with opposite polarity on the traces, calculation of coupling factors involving differential pairs is difficult.

### SUMMARY

An exemplary embodiment may comprise a method for verifying coupling in a differential trace pair group, including reading victim properties of a victim differential trace pair and culprit properties of a plurality of culprit differential trace pairs from a circuit design database. The method also includes calculating a plurality of coupling factors based on the victim properties and the culprit properties, one from each of the plurality of culprit differential trace pairs to the victim differential trace pair. The method also includes calculating a total coupling factor for the victim differential trace pair based on the plurality of coupling factors, and flagging the victim differential trace pair if the total coupling factor exceeds a total coupling threshold level.

### BRIEF DESCRIPTION OF THE DRAWINGS

Illustrative embodiments are shown in the accompanying drawings as described below.

FIG. 1 is a block diagram of an exemplary system for verifying coupling between differential trace pairs in an electrical circuit.

FIG. 2 is a perspective view of an exemplary differential pair group made up of differential trace pairs in an electrical circuit, shown on two neighboring layers of the circuit.

FIG. 3 is a view of a cross-section of the electrical circuit of FIG. 2, including a window around the exemplary differential pair group.

FIG. 4 is a screenshot of an exemplary control window for an embodiment of the differential trace pair coupling verification tool.

FIG. 5 is a flowchart summarizing an exemplary operation for verifying differential trace pair coupling.

### DESCRIPTION

The drawing and description, in general, disclose a method and apparatus for verifying the coupling from one or more culprit differential trace pairs in a differential pair group to a victim differential trace pair in the differential pair group. The differential pair group appears in an electrical circuit design such as an integrated circuit (IC), an IC package, a printed circuit board (PCB), etc. The method and apparatus for verifying differential trace pair coupling are not limited to use with any particular type of electrical circuit such as the IC package or PCB discussed herein. The method and apparatus are embodied in a software tool executed by a computer, either within an electronic design automation (EDA) software package or externally. The differential trace pair coupling verification tool reads a circuit design database describing the connections and physical properties of an electrical circuit. From these and other inputs to be described below, the differential trace pair coupling verification tool can flag deviations from acceptable coupling levels, enabling the designer to adjust the circuit to minimize crosstalk or other coupling-induced errors.

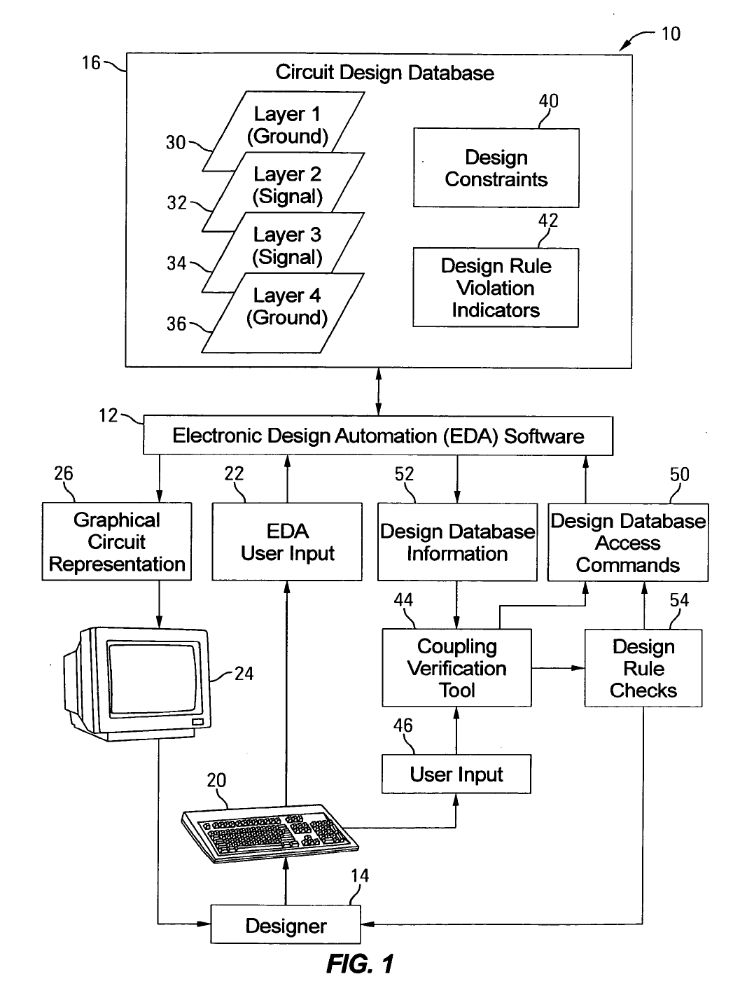

An exemplary system 10 for verifying differential trace pair coupling in an electrical circuit (such as an IC, an IC package, or a PCB) is illustrated in FIG. 1. This exemplary system 10 for verifying differential trace pair coupling is executed as part of an EDA software package 12. For example, the EDA software package 12 may comprise the Advanced Package Designer (APD) package design software available from Cadence Design Systems, Inc. of San Jose, Calif. However, it is important to note that the tool for verifying differential trace pair coupling is not limited to use with an EDA package 12, but may be executed independently using stored circuit information such as a circuit design database.

A human circuit or package designer 14 creates and edits a model of the circuit product using the EDA software 12. The designer 14 enters information through an interface such as a keyboard 20 or other input device to provide input 22 to the EDA software 12. Feedback is provided to the designer 14 on a monitor 24 or other output device. For example, if the designer 14 is creating a circuit layout or package, the end product is a design database 16 describing the physical layout of the circuit, such as the position, size and shape of traces, vias, component connection pads, etc. In this case, the monitor 24 may display a textual listing of the design database 16 or a graphical display of the circuit layout, displayed on a two-dimensional grid. Typical circuits include multiple layers 30, 32, 34 and 36, including layers 30 and 36 having ground planes, and layers 32 and 34 having signal traces, so the designer 14 may view and edit any desired layer. Vias, which are vertical conductors, are used to connect traces between multiple layers, whereas traces (horizontal or radial conductors) are used to connect components on a single layer.

Various formats exist for a design database 16. The format and contents of the design database 16 will therefore not be described in detail herein, as the differential trace pair coupling verification tool may be adapted for use with any system now existing or that may be developed in the future. The exemplary design database 16 is generated from a logical circuit design and other inputs such as design constraints 40, and comprises circuit layout information and other information such as indications of design rule violations, or design rule checks (DRCs) 42.

After a circuit has been designed, including the logical and physical layout (stored in the design database 16), the designer 14 invokes the differential trace pair coupling verification tool 44, providing user input 46 to guide the coupling verification as will be described in detail below. In this exemplary embodiment, the differential trace pair coupling verification tool 44 runs on the EDA software 12. For example, the differential trace pair coupling verification tool 44 of this exemplary embodiment may be implemented using a script language provided with the EDA software 12. Access to the design database 16 is therefore provided through the EDA software 12 using design database access commands 50. The differential trace pair coupling verification tool 44 issues design database access commands 50 to the EDA software 12, which accesses the desired portions of the design database 16. The EDA software 12 then provides the requested design database information 52 to the differential trace pair coupling verification tool 44.

The differential trace pair coupling verification tool 44 searches the design database 16 and uses numerical formulas or an analytical field solver or a combination thereof to calculate the total coupling factor of a specified victim differential trace pair within a differential pair group. The resulting total coupling factor is compared with the desired value, and if the total coupling factor is not within the specified tolerance, or if it exceeds a specified threshold level, the differential trace pair coupling verification tool 44 flags the error. In this exemplary embodiment, the differential trace pair coupling verification tool 44 flags the error by attaching a Design Rule Check (DRC) 54 to the victim differential trace pair, either adding the DRC 54 directly to the design database 16 (not shown) or passing the information through the EDA software 12 using the design database access commands 50, so that the DRC 54 is stored (e.g., 42) in the design database.

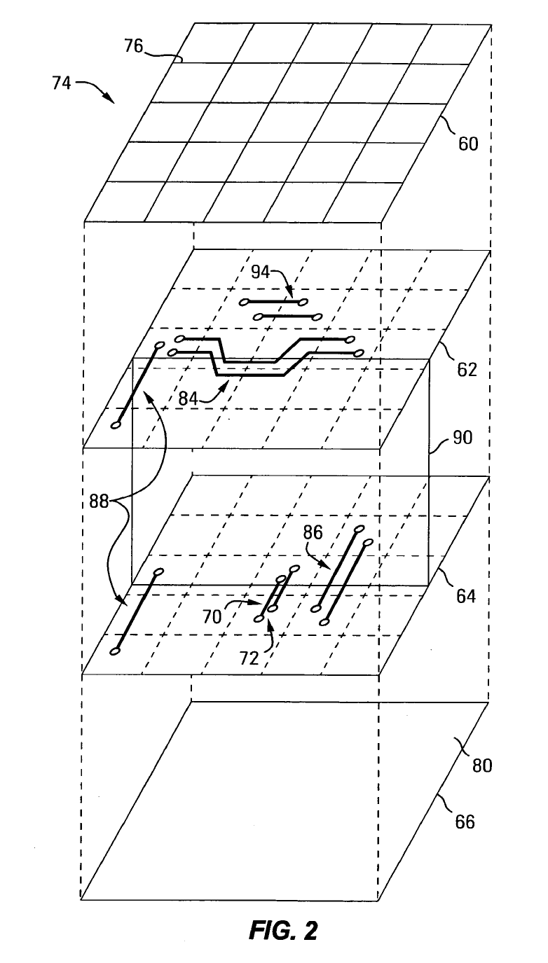

An exemplary circuit layout in which differential trace pair coupling may be verified is illustrated in FIG. 2. The exemplary circuit has multiple layers 60, 62, 64 and 66 and both differential trace pairs (e.g., 70) and differential via pairs (e.g., 72). It should be noted that the exemplary circuit 74 is not drawn to scale, and only relevant features are included to illustrate the operation of the differential trace pair coupling verification tool 44. It should also be noted that the arrangement of layers and elements on the layers 60-66 is purely exemplary. Grid lines are provided on the two center layers 62 and 64 to aid in correlating features between layers.

Ground planes may be provided on one or more layers 60 and 66, either as a grid of ground lines 76 (illustrated by solid grid lines in the top layer 60 of FIG. 2) or as a solid plane 80. The differential trace pair coupling verification tool 44 is described herein for verifying the coupling factor within a differential pair group from one or more culprit differential trace pairs (e.g., 84, 86 and 88) to a victim differential trace pair (e.g., 70) such as those illustrated in FIG. 2. The differential trace pair coupling verification tool 44 enables a designer to easily calculate the susceptibility of the differential trace pairs in the circuit to capacitive crosstalk, or interference caused by signals becoming partially superimposed on each other due to electrostatic (capacitive) coupling between the conductors carrying the signals.

The differential trace pair coupling verification tool 44 obtains layout information about the differential trace pair group to be considered from the design database 16. As discussed above, this design database 16 may comprise layout information containing the names, sizes, location and layer, etc., of differential trace pairs that carry signals in the electrical circuit. The design database may be created by EDA software for logical circuit design followed by EDA software for physical circuit layout such as the APD package designer. In this exemplary embodiment, the differential trace pair coupling verification tool 44 runs on top of the EDA software 12 as a script. For example, if the EDA software 12 comprises the APD package designer, the differential trace pair coupling verification tool 44 may be implemented as a script using the “Skill” scripting language and executed within the APD design environment. In this example, the circuit model access commands issued by the differential trace pair coupling verification tool 44 may comprise Skill commands issued to the APD package designer. Alternatively, the differential trace pair coupling verification tool 44 may be implemented as a standalone software application or as a script in another language such as Perl, as desired or as needed to operate with other EDA software.

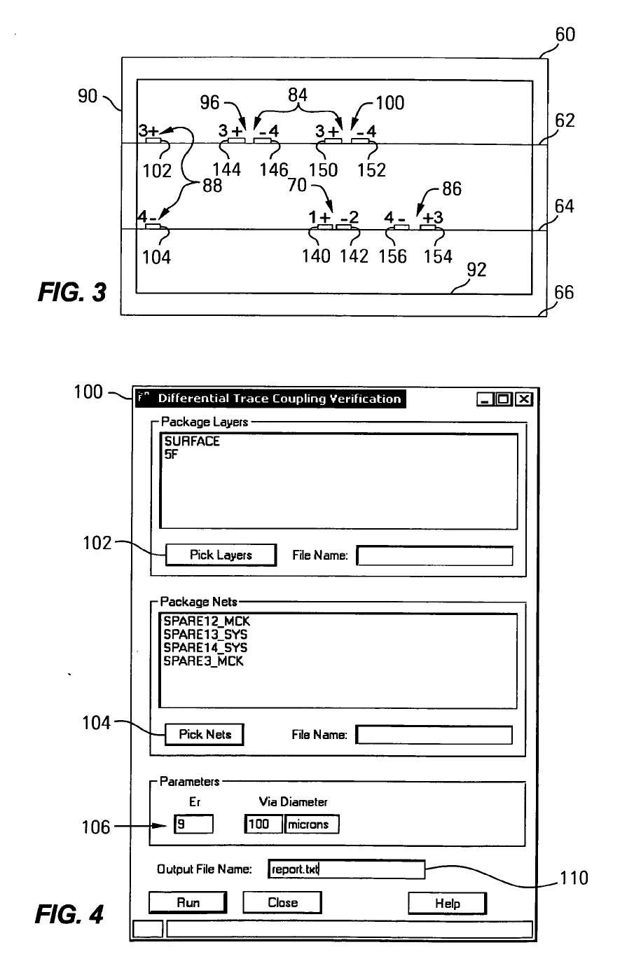

Referring now to FIG. 3, a cross-section 90 of the exemplary circuit 74 is shown in order to illustrate the operation of the differential trace pair coupling verification tool 44. The cross-section 90 of the exemplary circuit 74 is not drawn to scale. Additionally, the placement of conductors is purely exemplary and is not intended to represent an actual circuit layout or to limit the differential trace pair coupling verification tool 44 disclosed herein. The coupling factors for a victim differential trace pair 70 within a differential pair group are calculated based on the cross-sectional layout of the differential trace pairs. The cross-section 90 is taken at any desired point along the length of the victim differential trace pair 70, and is oriented and sized in any suitable fashion according to the desired differential pair group. In the exemplary embodiment of the differential trace pair coupling verification tool 44, the cross-section 90 is co-planar with the page and includes traces on layers 62 and 64. As will be discussed below, the exemplary embodiment of the differential trace pair coupling verification tool 44 considers only differential trace pairs, so any other circuit elements lying within the cross-section 90, such as vias, single traces, pads, etc. are filtered out when reading the design database 10 and are not included in the coupling calculations. Therefore, only differential trace pairs (e.g., 70, 84, 86 and 88) are included in the cross-section 90 illustrated in FIG. 3.

The differential pair group to be considered in the coupling calculations may be specified in any suitable manner. For example, differential trace pairs (e.g., 70, 84, 86 and 88) may be explicitly specified for inclusion in the coupling calculation. Alternatively, a window 92 may be established around a selected victim differential trace pair 70. For example, a distance may be specified around the victim differential trace pair 70, within which all differential trace pairs will be identified as culprit differential trace pairs and included in the differential pair group for the coupling calculation. The exemplary window 92 illustrated in FIG. 3 may be specified as a distance from the victim differential trace pair 70, or as a width for a square window within which the victim differential trace pair 70 is centered, or in any other suitable manner for defining the window 92. Differential trace pairs (e.g., 84, 86 and 88) within the window 92 (other than the victim differential trace pair 70) are identified as culprit differential trace pairs and are included in the differential pair group, while differential trace pairs (e.g., 94) outside the window 92 or cross-section 90 are excluded.

Note that several culprit differential trace pairs (e.g., 84) in a cross-section 90 may belong to the same signal. In other words, a differential trace pair (e.g., 84) may move through a single cross-section 90 in several locations and thus appear twice 96 and 100. Both appearances 96 and 100 of the culprit differential trace pair 84 in the cross-section 90 may couple to a victim differential trace pair 70. However, the appearances 96 and 100 of the differential trace pair 84 must either both be culprits, or one must be a victim and the other neglected in the coupling calculations, rather than being one culprit and one victim, because they are both parts of the same signal and any coupling between them would likely be insignificant or nonexistent. The exemplary differential trace pair coupling verification tool 44 may be adapted to check the signal or net to which each differential trace pair in the differential pair group belongs to avoid calculating coupling between different portions of the same net.

Note also that the culprit differential trace pair 84 is not parallel with the victim differential trace pair 70 (see FIG. 2), however, because the coupling is calculated for the cross-section 90, the coupling from the culprit differential trace pair 84 to the victim differential trace pair 70 is the same whether the victim and culprit are routed in parallel or at another angle.

The individual traces 102 and 104 of a differential trace pair 88 may also be routed on different layers 62 and 64, but this does not affect the coupling calculation other than through the impact on the layout and configuration of the cross-section 90, such as the spacing between the individual traces 102 and 104 of a differential trace pair 88 and the victim differential trace pair 70.

The exemplary differential trace pair coupling verification tool 44 obtains any needed user input that is not hard-coded into the tool 44 in any suitable manner. For example, input may be entered by the designer 14 in a dialog box 100 in a graphical user interface, as illustrated in FIG. 4. The inputs used by the differential trace pair coupling verification tool 44 depend upon the techniques used in selecting the differential pair group, including the victim differential trace pair and the culprit differential trace pairs. The inputs used also depend upon the techniques used in calculating the coupling values. For example, the exemplary dialog box 100 illustrated in FIG. 4 enables the designer 14 to specify cross-section 90 locations and victim differential trace pairs by selecting the circuit package layers 102 included in the cross-section, and by selecting the differential pair signal nets 104 on which differential trace pairs should be considered. Physical properties 106 used in the coupling calculations may also be entered, such as the dielectric constant or electric permittivity epsilon (εᵣ) of the circuit material, and the size of the differential traces. Output options may also be specified, such as the name 110 of an output file.

Other parameters may be entered as user input or hard-coded in the differential trace pair coupling verification tool 44, such as:
Polarity assignments for differential trace pairs
Window size or differential pair group specification
Coupling threshold
Material properties or capacitance or inductance matrices

The polarity assignments are used in one exemplary method of calculating coupling factors. The two conductors in each differential trace pair are each assigned a polarity, one positive and one negative, because when operated in odd-mode, each conductor of the differential trace pair carries equal but opposite currents called odd-mode signals. Polarity assignments may be specified by the designer 14. As will be described in more detail below, the coupling calculation for the total coupling factor may be performed based on the designer's 14 polarity assignments, or may be adapted to determine a worst case coupling factor for any possible polarity assignment configuration, in which case the differential trace pair coupling verification tool 44 may randomly assign polarities if desired.

The differential pair group for a coupling calculation may be identified in any suitable manner, as described above, such as by specifying a window size around a victim differential trace pair or by specifying the differential trace pairs to be included in a differential pair group for which coupling is calculated.

If a window is specified, in the exemplary embodiment the window indicates the size of a cross-section of the electrical circuit around the victim differential trace pair, with the window and cross-section being substantially perpendicular to the victim differential trace pair. Alternatively, the orientation of the cross-section may be specified at some angle other than perpendicular to the victim differential trace pair. The layers to be included in the window may also be specified.

The acceptable coupling levels may be specified as a threshold value or in any other suitable manner. Coupling values within the range below the coupling threshold value are acceptable, while higher coupling values will trigger the flagging of an error, such as a DRC, for the victim differential trace pair. Note that a variety of definitions may be applied to the establishment of the threshold value. For example, the threshold value may be the highest acceptable coupling value, above which any coupling value would trigger an error flag. The threshold value may alternatively be the lowest unacceptable coupling value, below which the coupling value must remain to avoid triggering an error flag. These various ways of defining the threshold are equivalent and accomplish the same function of distinguishing acceptable coupling levels from unacceptable coupling levels, and are all to be viewed as being within the scope of the claims.

The designer 14 may also specify the material properties, such as the dielectric constant or electric permittivity epsilon (εᵣ) and the magnetic permeability mu (μᵣ), if needed for the coupling calculation and if not hard-coded into the differential trace pair coupling verification tool 44. The material properties are the characteristics of the material in which the traces are embedded, such as the substrate of the IC or PCB. Different material properties may be needed based on the method by which coupling is calculated, as will be described in more detail below. For example, coupling may be calculated based on capacitance values for the elements of the differential pair group. If these capacitance values are available in the design database, the dielectric constant may not be needed for the coupling calculation. Similarly, if inductance values are available, from which capacitance values may be derived, the dielectric constant may not be needed. If the capacitance values are calculated during the coupling calculation, the dielectric constant may be needed.

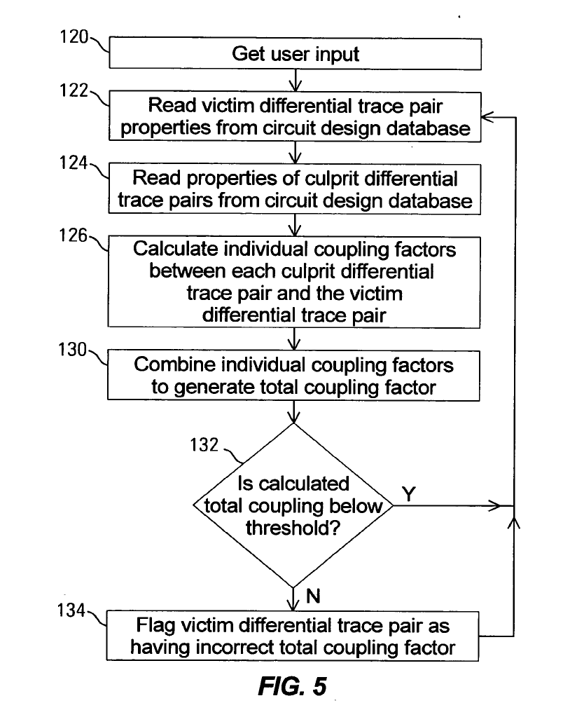

An exemplary operation for verifying differential trace pair coupling is summarized in the flowchart of FIG. 5. Once the differential trace pair coupling verification tool 44 has obtained 120 any needed inputs as discussed above, the differential trace pair coupling verification tool 44 reads properties 122 of the victim differential trace pair (e.g., 70) and properties 124 of the culprit differential trace pairs (e.g., 84, 86 and 88), respectively. This identification may be performed by the user specifying particular differential trace pairs or nets to consider, or by the differential trace pair coupling verification tool 44 running through the design database 16 to verify coupling for all differential trace pairs or a designer-specified subset of them. The differential trace pair coupling verification tool 44 then calculates 126 individual coupling factors between each culprit differential trace pair (e.g., 84, 86 and 88) and the victim differential trace pair (e.g., 70), as will be described in more detail below. The differential trace pair coupling verification tool 44 combines 130 the individual coupling factors to generate a total coupling factor for the victim differential trace pair (e.g., 70) within the differential trace pair group. If 132 the calculated total coupling factor is above the established threshold, the differential trace pair coupling verification tool 44 flags 134 the victim differential trace pair (e.g., 70) as having an incorrect total coupling factor.

The victim differential trace pair (e.g., 70) may be flagged 134 in any desired manner, as discussed above. For example, the differential trace pair coupling verification tool 44 may report the error directly to the designer 14, may store a list of coupling errors separately, may place a DRC directly in the circuit design database 16, or may report the error to the EDA software 12, etc., as desired. If the design database 16 includes an entry for the victim differential trace pair, the DRC may be placed in that entry along with an indication of the location and other parameters of the cross-section. Alternatively, the DRC may be placed as needed to identify the victim differential trace pair 70 having the coupling error, such as in the entries for the individual traces making up the victim differential trace pair. The DRC entry may additionally indicate the location of the window 94 and/or cross-section 90, and may identify the culprit differential trace pairs (e.g., 84, 86 and 88) that contributed to the erroneous total coupling factor.

After the total coupling factor is calculated 130 and verified 132 for the victim differential trace pair (e.g., 70) and any errors have been flagged 134, the next victim differential trace pair may be identified, properties obtained 122 and the process repeated until all desired differential pairs have checked. Multiple coupling checks may also be performed at different locations along a single victim differential trace pair.

The exemplary method of calculating the independent coupling factors and the total coupling factor will now be described in more detail. The coupling factors, both independent and total, may be calculated in one exemplary embodiment as described in the U.S. patent application for Karl J. Bois et al., entitled “METHOD AND APPARATUS FOR DETERMINING WORST CASE COUPLING WITHIN A DIFFERENTIAL PAIR GROUP”, filed concurrently herewith, Attorney Docket No. 200311785-1, which is incorporated by reference herein for all that it contains. Referring again to FIG. 3, the exemplary coupling calculations will be described with respect to the differential pair group consisting of the victim differential trace pair 70 and three culprit differential trace pairs 84, 86 and 88. Again, the coupling calculations are performed for the differential pair group based on a two-dimensional cross-section 90 of the differential pair group.

The two conductors in each differential trace pair are assigned a polarity, one positive and one negative, as described above. The left conductor 140 of the victim differential trace pair 70 is assigned a positive polarity and is designated as conductor number one for the coupling equations. The right conductor 142 of the victim differential trace pair 70 is assigned a negative polarity and is designated as conductor number two. The left conductor 144 of the first appearance 96 of the culprit differential trace pair 84 is assigned a positive polarity and is designated as conductor number three for the coupling equations. The right conductor 146 of the first appearance 96 of the culprit differential trace pair 84 is assigned a negative polarity and is designated as conductor number four. The left conductor 150 of the second appearance 100 of the culprit differential trace pair 84 is assigned a positive polarity and is also designated as conductor number three for the coupling equations. The right conductor 152 of the second appearance 100 of the culprit differential trace pair 84 is assigned a negative polarity and is also designated as conductor number four.

Note that the polarities assigned the two appearances 96 and 100 of the culprit differential trace pair 84 are contradictory, that is, although the left conductor 144 of the first appearance 96 is part of the same trace as the right conductor 152 of the second appearance 100 (see FIG. 2), they have been assigned opposite polarities. Because the exemplary coupling calculation maximizes the total coupling factor regardless of assigned polarity as will be described in detail below, this contradictory polarity assignment is not important. In an alternative embodiment, in which the total coupling factor is not maximized but is calculated according to the polarities assigned by the designer 14, the designer 14 may, but probably would not, assign the polarities shown for the two appearances 96 and 100 of the culprit differential trace pair 84.

The right conductor 154 of the culprit differential trace pair 86 is assigned a positive polarity and is also designated as conductor number three for the coupling equations. The left conductor 156 of the culprit differential trace pair 86 is assigned a negative polarity and is also designated as conductor number four.

The top conductor 102 of the culprit differential trace pair 88 is assigned a positive polarity and is also designated as conductor number three for the coupling equations. The bottom conductor 104 of the culprit differential trace pair 88 is assigned a negative polarity and is also designated as conductor number four.

The conductors of both appearances 96 and 100 of culprit differential trace pair 84 and of culprit differential trace pairs 86 and 88 are all designated as numbers three and four for the coupling equations, because the coupling factor from each culprit differential trace pair (e.g., 84, 86 and 88) to the victim differential trace pair 70 is individually calculated, then combined to form a total coupling factor.

The individual coupling factors are calculated in the exemplary embodiment based on capacitance values for the elements of the differential pair group. Capacitance values for the elements of the differential pair group may be calculated in the differential trace pair coupling verification tool 44 or may be externally calculated and provided as an input using well known electromagnetic solver techniques, based on parameters such as the dielectric material and the shape and the spatial distribution of the conductors. The capacitance values for the differential trace pair coupling verification tool 44 are found in the capacitance matrix for the victim differential trace pair 70 and culprit differential trace pairs (e.g., 84, 86 and 88). The capacitance matrix for the system containing the victim differential trace pair 70 and one culprit differential trace pair (e.g., 84) is as follows:

$$[ C ] = [ \begin{matrix}{C}_{11} & - {C}_{12} & - {C}_{13} & - {C}_{14} \\ - {C}_{21} & {C}_{22} & - {C}_{23} & - {C}_{24} \\ - {C}_{31} & - {C}_{32} & {C}_{33} & - {C}_{34} \\ - {C}_{41} & - {C}_{42} & - {C}_{43} & {C}_{44} \end{matrix} ]$$

where Cᵢⱼ=Cⱼᵢ. The subscripts in the capacitance matrix refer to the numeric designations one through four given the individual conductors as discussed above. For example, the capacitance C₁₂ in the capacitance matrix is the capacitance between the positive trace 140 (designated conductor 1) and the negative trace 142 (designated conductor 2) of the victim differential trace pair 70. Similarly, the capacitance C₂₃ in the capacitance matrix is the capacitance between the negative trace 142 of the victim differential trace pair 70 and the positive trace 144 of the first appearance 96 of the culprit differential trace pair 84. Again, the capacitance matrix is for the system including the victim differential trace pair 70 and one culprit differential trace pair (e.g., 96) in the cross-section 90.

Again, the capacitance values may be calculated or provided in any suitable manner. For example, the inductance matrix [L] of the victim and culprit differential trace pairs 70 and 96 may be calculated numerically using any suitable technique, such as a finite element routine, or using a generic analytical field solver, and the capacitance matrix [C] may then be calculated numerically from the inductance matrix using a formula such as [C]=(μ₀ε₀μᵣεᵣ)/[L].

The individual coupling factor k from a culprit differential trace pair (e.g., 96) to the victim differential trace pair 70 is calculated using the capacitance values as follows:

$${k}_{21} = \frac{{C}_{13} + {C}_{24} - ( {C}_{14} + {C}_{23} )}{{C}_{11} + {C}_{22} - 2 {C}_{12}}$$

The subscripts to the left of the equality sign each identify a differential trace pair in the differential pair group, with the victim differential trace pair being number 1 and the culprit differential trace pair being number 2 in this case. The subscripts to the right of the equality sign each identify a conductor in the differential pair group, as designated above.

Again, the individual coupling factors k₂₁, k₃₁, etc. are calculated between the victim differential trace pair 70 and a single culprit differential trace pair 96, 100, 86 and 88 at a time, each in turn. The resulting individual coupling factors are then combined to form a total coupling factor for the victim differential trace pair within the differential pair group. This combining may be performed in any suitable manner. In one exemplary embodiment, the individual coupling factors are calculated based on the polarity assignments made by the designer 14 and are summed to form the total coupling factor. In this exemplary embodiment, the individual coupling factors may have different signs, with some being positive and some being negative, so the resulting total coupling factor may be somewhat less that the worst case coupling value.

In another exemplary embodiment, the individual coupling factors may be combined in a manner that maximizes the total coupling factor to generate a worst case coupling factor, regardless of the polarity assignments. The individual coupling factors may be combined to form the worst case coupling factor according to the following equation:

$${k}_{worst} = {\sum }_{m = 2}^{N} \vert {k}_{m 1} \vert$$

As described above with respect to the individual coupling factor equation, the victim differential trace pair 70 is identified as pair 1 and the culprit differential trace pairs are identified as 2 and up. The term N in the equation for k_{worst} is the number of differential trace pairs in the differential pair group (or 5 in the exemplary differential pair group of FIG. 3). The equation for k_{worst} sums the absolute values of the individual coupling factors k₂₁ and k₃₁.

Alternatively, the individual coupling factors may be combined in other manners to generate the worst case coupling factor, as described in the document incorporated above.

The differential trace pair coupling verification tool 44 makes it simple for the designer 14 to verify the coupling factor of numerous victim differential trace pairs in even complex circuit designs, thereby flagging incorrect coupling values that may lead to errors in the circuit.

Various computer readable or executable code or electronically executable instructions have been referred to herein. These may be implemented in any suitable manner, such as software, firmware, hard-wired electronic circuits, or as the programming in a gate array, etc. Software may be programmed in any programming language, such as machine language, assembly language, or high-level languages such as C or C++. The computer programs may be interpreted or compiled.

Computer readable or executable code or electronically executable instructions may be tangibly embodied on any computer-readable storage medium or in any electronic circuitry for use by or in connection with any instruction-executing device, such as a general purpose processor, software emulator, application-specific circuit, a circuit made of logic gates, etc. that can access or embody, and execute, the code or instructions.

Methods described and claimed herein may be performed by the execution of computer readable or executable code or electronically executable instructions, tangibly embodied on any computer-readable storage medium or in any electronic circuitry as described above.

A storage medium for tangibly embodying computer readable or executable code or electronically executable instructions includes any means that can store, transmit, communicate, or in any way propagate the code or instructions for use by or in connection with the instruction-executing device. For example, the storage medium may include (but is not limited to) any electronic, magnetic, optical, or other storage device, or any transmission medium such as an electrical conductor, an electromagnetic, optical, infrared transmission, etc. The storage medium may even comprise an electronic circuit, with the code or instructions represented by the design of the electronic circuit. Specific examples include magnetic or optical disks, both fixed and removable, semiconductor memory devices such as memory cards and read-only memories (ROMs), including programmable and erasable ROMs, non-volatile memories (NVMs), optical fibers, etc. Storage media for tangibly embodying code or instructions also include printed media such as computer printouts on paper which may be optically scanned to retrieve the code or instructions, which may in turn be parsed, compiled, assembled, stored and executed by an instruction-executing device. The code or instructions may also be tangibly embodied as an electrical signal in a transmission medium such as the Internet or other types of networks, both wired and wireless.

While illustrative embodiments have been described in detail herein, it is to be understood that the concepts disclosed herein may be otherwise variously embodied and employed, and that the appended claims are intended to be construed to include such variations, except as limited by the prior art.

1. A computer-implemented method for verifying coupling in a differential trace pair group, comprising:
reading victim properties of a victim differential trace pair from a circuit design database;
reading culprit properties of a plurality of culprit differential trace pairs from said circuit design database;
calculating a plurality of coupling factors based on said victim properties and said culprit properties, one from each of said plurality of culprit differential trace pairs to said victim differential trace pair;
calculating a total coupling factor for said victim differential trace pair based on said plurality of coupling factors; and
flagging said victim differential trace pair if said total coupling factor exceeds a total coupling threshold level.

2. The method of claim 1, wherein said differential trace pair group comprises said victim differential trace pair and said plurality of culprit differential trace pairs.

3. The method of claim 1, wherein said reading said victim properties and said culprit properties comprise reading material properties.

4. The method of claim 1, wherein said reading said victim properties and said culprit properties comprise reading properties of a cross-section of said victim differential trace pair and said plurality of culprit differential trace pairs.

5. The method of claim 1, further comprising obtaining said total coupling threshold level and comparing said total coupling factor with said total coupling threshold level.

6. The method of claim 1, said flagging comprising storing a coupling design rule check in said circuit design database for said victim differential trace pair.

7. The method of claim 1, further comprising identifying said plurality of culprit differential trace pairs.

8. The method of claim 7, wherein said identifying said plurality of culprit differential trace pairs comprises establishing a two-dimensional window around said victim differential trace pair, wherein all other differential trace pairs within said two-dimensional window are identified as said plurality of culprit differential trace pairs.

9. The method of claim 8, wherein said two-dimensional window is oriented substantially perpendicular to said victim differential trace pair.

10. The method of claim 8, said establishing said two-dimensional window comprising reading a distance from said victim differential trace pair.

11. The method of claim 1, said calculating said total coupling factor for said victim differential trace pair based on said plurality of coupling factors comprising summing an absolute value of each of said plurality of coupling factors.

12. The method of claim 1, said calculating said total coupling factor comprising identifying a configuration of polarity assignments for said victim differential trace pair and said plurality of culprit differential trace pairs which maximizes said total coupling factor, said total coupling factor comprising a worst case coupling factor.

13. An apparatus for checking a coupling level within a differential trace pair group, comprising:
a. at least one computer readable medium; and
b. computer readable program code stored on said at least one computer readable medium, said computer readable program code comprising:
i. program code for reading properties for a victim differential trace pair and a plurality of culprit differential trace pairs from a circuit design database;
ii. program code for calculating a total coupling factor between said victim differential trace pair and said plurality of culprit differential trace pairs; and
iii. program code for flagging said victim differential trace pair if said total coupling factor exceeds a threshold value.

14. The apparatus of claim 13, said program code for calculating said total coupling value comprising program code for calculating a plurality of coupling values, one between each of said plurality of culprit differential trace pairs and said victim differential trace pair, and program code for combining said plurality of coupling values to form said total coupling value.

15. The apparatus of claim 14, said program code for combining comprising program code for summing an absolute value of each of said plurality of coupling values, said total coupling factor comprising a worst case coupling factor.

16. The apparatus of claim 13, further comprising program code for reading said threshold value.

17. The apparatus of claim 13, further comprising program code for identifying said plurality of culprit differential trace pairs in said circuit design database, said victim differential trace pair and said plurality of culprit differential trace pairs forming said differential trace pair group.

18. The apparatus of claim 17, said program code for identifying said plurality of culprit differential trace pairs comprising program code for establishing a two-dimensional window around said victim differential trace pair within which all other differential trace pairs are identified as said plurality of culprit differential trace pairs, said two-dimensional window forming a cross-section substantially perpendicular to said victim differential trace pair.

19. The apparatus of claim 13, said program code for flagging said victim differential trace pair comprising program code for placing a coupling design rule check in said circuit design database.

20. The apparatus of claim 13, wherein at least a portion of said computer readable program code comprises a script for execution in a design environment of an electronic circuit design automation software application.

21. An apparatus for verifying differential trace pair coupling within a differential trace pair group, comprising:
means for reading properties of a victim differential trace pair and a plurality of culprit differential trace pairs from a circuit design database, said victim differential trace pair and said plurality of culprit differential trace pairs comprising said differential trace pair group;
means for calculating a total coupling factor from said plurality of culprit differential trace pairs to said victim differential trace pair; and
means for flagging said victim differential trace pair in said circuit design database if said total coupling factor exceeds a threshold value.

22. The apparatus of claim 21, wherein differential traces in said differential trace pair group are assigned polarities during said calculating, and wherein said total coupling factor comprises a worst case coupling factor that is maximized for any possible arrangement of polarity assignments.
